(19) United States
(12) Patent Application Publication
(10) Pub. No.: US 2006/0277010 A1
(43) Pub. Date: Dec. 7, 2006

(54) Parameterization of a simulation working model

(76) Inventors: Herbert Schutte, Borchen (DE); Jorg Sauer, Detmold (DE); Tino Schulze, Paderborn (DE); Andre Klawa, Gutersloh (DE)

Correspondence Address: CHADBOURNE & PARKE L.L.P., 30 Rockefeller Plaza, New York, NY, 10112, US

(21) Appl. No.: 11/446,476

(22) Filed: Jun. 2, 2006

(30) Foreign Application Priority Data
Jun. 3, 2005 (DE) 10 2002 026 040.3

(51) Int. Cl. G06G 7/48

(52) U.S. Cl. 703/8

(57) ABSTRACT

The invention relates to a process for the parameterization of a software-implemented working model of a simulation environment, which comprises a multitude of simulation model components and is loaded onto simulation hardware, particularly in order to simulate a test environment of at least one motor vehicle control system interfaced with the simulation hardware or the simulation of a motor vehicle control system running on the simulation hardware, whereby the working model is analyzed in relation to the simulation model components contained therein and for each detected simulation model component there is generated and displayed a user interface by the automatic selection out of a mask databank of at least one input/output mask allocated to the simulation model component and by the automatic selection out of a parameter-mask allocation databank of the parameters allocated to an input/output mask.

### RELATED APPLICATIONS

The present invention claims all rights of priority to German Patent Application No. 10 2005 026 040.3, filed on Jun. 3, 2005, which is hereby incorporated by reference.

### FIELD OF THE INVENTION

The invention relates to a process for the parameterization of a software-implemented working model of a simulation environment, which comprises a multitude of simulation model components and is loaded onto simulation hardware, in particular to simulate a test environment for at least one motor vehicle control system interfaced with the simulation hardware or a simulation of a motor vehicle control system running on the simulation hardware.

### BACKGROUND OF THE INVENTION

Along with the information and communication technology, the automotive industry counts among the most innovative lines of business worldwide. A substantial segment thereof is represented by the installation of technically complex systems—such as novel control units—on motor vehicles. Whether in engine management, chassis control, driver assistance systems or telematics, control units nowadays attend to the most varied control and regulation tasks with the aid of their sensor systems, actuator blocks and technologic software-implemented control algorithms.

### SUMMARY OF THE INVENTION

The present invention automatically adjusts and optimizes the parameterization of a simulation model based on a changed composition of model components, by way of automatic adaptation and optimization of user and parameterization interfaces.

In addition, users are able to delete and/or replace model components (for example, axial shock absorbers) with their own or other models.

The development of control systems for the automotive trade is nowadays mostly based on models, comprising a variety of steps which may be defined as follows.

In positing the tasks of a technical control system, first and foremost is the creation of a mathematical model of a technical and physical process impressed with the desired dynamic behavior. Based on the resulting abstract mathematical model, it is possible to test a variety of control concepts, again available exclusively as a mathematical model concept, within the framework of an initial numerical simulation on the development system. This stage comprises the phase of modeling and design of the controller, based mostly on computer-assisted modeling tools, such as MATLAB Simulink.

In the next phase, the control system designed in the mathematical model is transferred onto prototyping hardware for a prototypical test of the control function. Next, the prototyping hardware is brought into contact with the real physical environment. Inasmuch as the transfer of the abstractly formulated control system from a modeling tool onto the prototyping hardware is to the widest possible extent automated, this second phase is spoken of as the Rapid Control Prototyping (RCP) of function prototyping.

If the technical problems of the control are resolved by the control system driven by the prototyping hardware, the control algorithm is transferred within the framework of the implementation of the control system, together with its operating system, onto the production control unit to be ultimately employed in practice. This process is known as implementation.

In principle, there is now a ready-made control unit available, and test runs may consequently be carried out. To afford security against malfunctions, such test runs are conducted under adverse and extreme conditions.

Inasmuch as at this stage of the development the vehicle prototypes are mostly not yet available, in order to permit parallel development consistent with the shortened development times, test scenarios are implemented with the aid of simulators. In most cases, simulators consist of a high-speed computer unit and several I/O cards to which the actual control unit is linked. In other words, the real control unit so developed is tested, in that it is exposed to a simulated environment (control run) on the simulator and/or the simulation hardware. This stage of development is designated as the HIL (Hardware-in-the-Loop) test.

A further advantage of such a procedure lies in the fact that a single control unit as well as a complete control network can be tested with the aid of a simulated environment. This permits virtual test runs long before the first vehicle prototype is ready and available, with the resulting huge money and time savings. Such a simulator can also execute test runs beyond the borderline limits feasible for real vehicles. In addition, test runs are reproducible and can be automated.

In order for such virtual test runs and/or tests to be realized, appropriate simulation models must be developed, optimally reflecting the modeling environment and/or control run. These simulation models may be models of vehicles, automotive dynamics, engines, entertainment systems or telematic simulation.

For the simulation, the automated simulation models are transferred for example in C-code and then compiled. After compilation and interfacing, the implementing program can be brought to implementation on simulation hardware.

A basic requirement for simulation hardware is its real-time capability of simulating a dynamic vehicle behavior. In order to afford perfect interplay of real control system, simulation model and simulation hardware, development tools are used to facilitate the dating and/or parameterization of the situation models as well as the automation and management of virtual tests. Such development tools comprise, for example, the AutomationDesk and ControlDesk programs of the firm of dSPACE.

With the growing number and complexity of simulation models, greater demands are also placed on the administrative tools.

Simulation model contents may, for example, constitute main components and subsidiary components. Hence, a complete simulation model consists of a main component and sub-components, making up the model components.

The main component, for example, may be a simulation model for a drive shaft, which in turn may consist of additional sub-components, comprising simulation models for the clutch, the differential or the gears.

If the simulation models change in relation to the employed simulation model components, it is necessary at this state of the art to modify manually the user interfaces, since they were originally programmed for a fixed model.

For example, if a sub-component is deleted in the simulation model, it is also necessary to adjust the graphical user interface (GUI) or mask to match this model component.

In this concrete case, manual precautions must be taken in order not to no longer display the GUI, that is the user interface, for the deleted model component and to prevent the transfer of the pertinent parameters onto the real time hardware. The same is true by analogy to the addition of simulation model components.

A further problem consists in the fact that when a particular parameterization program identifies parameters of different model components in one common user interface (GUI) and one of the simulation model components is deleted, there is again a need for manual adjustments in order to prevent the input of parameters belonging to the deleted simulation model components.

In complex simulation model structures with numerous simulation model components, this invariably entails a high outlay for manual adjustments.

According to the present state of the art, certain simulation model components are activated or deactivated in order to adapt the user interfaces. In the case of deactivation, they are nevertheless still stored in memory and, even if possibly no longer needed, they must nevertheless be translated for example in C-code and downloaded onto the simulation hardware, although the pertinent portions of the program are no longer executed.

Considerable memory storage is thereby wasted on unnecessary, but loaded simulation components, further impairing the speed of simulation hardware, as provision must be made for inquiries as to whether certain model components are active and need running time or are inactivated and must be by-passed.

### BRIEF DESCRIPTION OF THE DRAWINGS

An exemplified embodiment is described in the following figures which show:

FIG. 1. A global simulation model with the main structural components, as for example engine or drivetrain,

FIG. 2. Some of the substructure components of the main structural drivetrain component,

FIG. 3. A model structure (for ex. in XML format) providing information on the main structural components, the substructure components, as well as the parameters utilized in the working model,

FIG. 4. A GUI wherein are displayed the parameters of model components of several different substructure components,

FIG. 5. Schematic correlation of working simulation models, global simulation models and descriptive data (effective model structure and theoretical model structure).

### DETAILED DESCRIPTION OF THE INVENTION

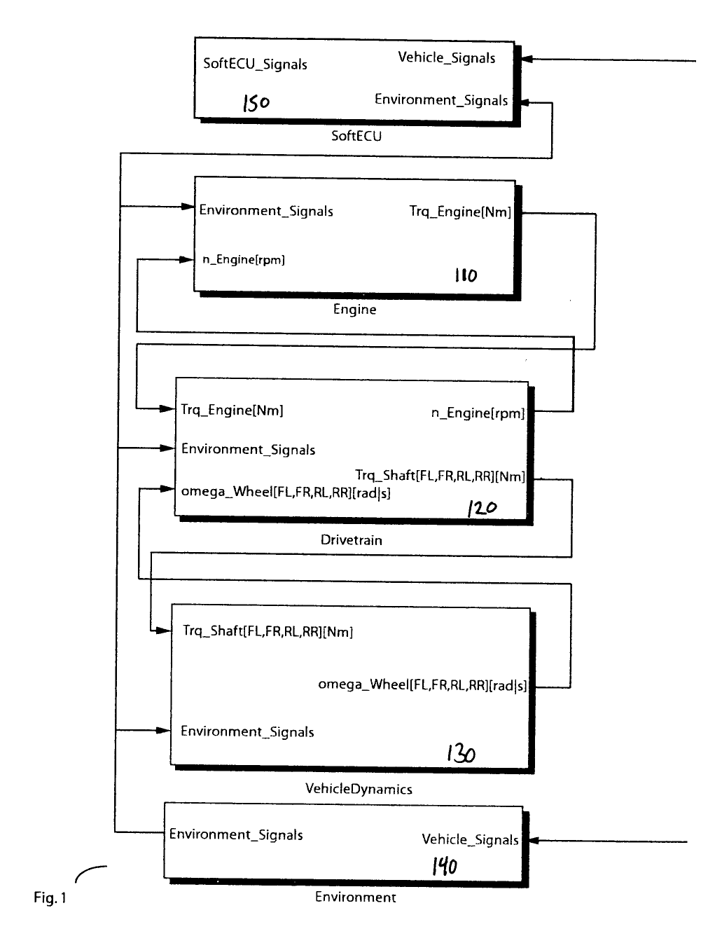

FIG. 1 shows an exemplary global vehicle simulation model comprising the high level components of the model and signal transfer between the components. The high level vehicle components include, engine 110, drive train 120, and vehicle dynamics 130. Also included in the global model are external effects such as environment 140 and the Soft ECU 150, which as described below can provide an off-line software simulation environment.

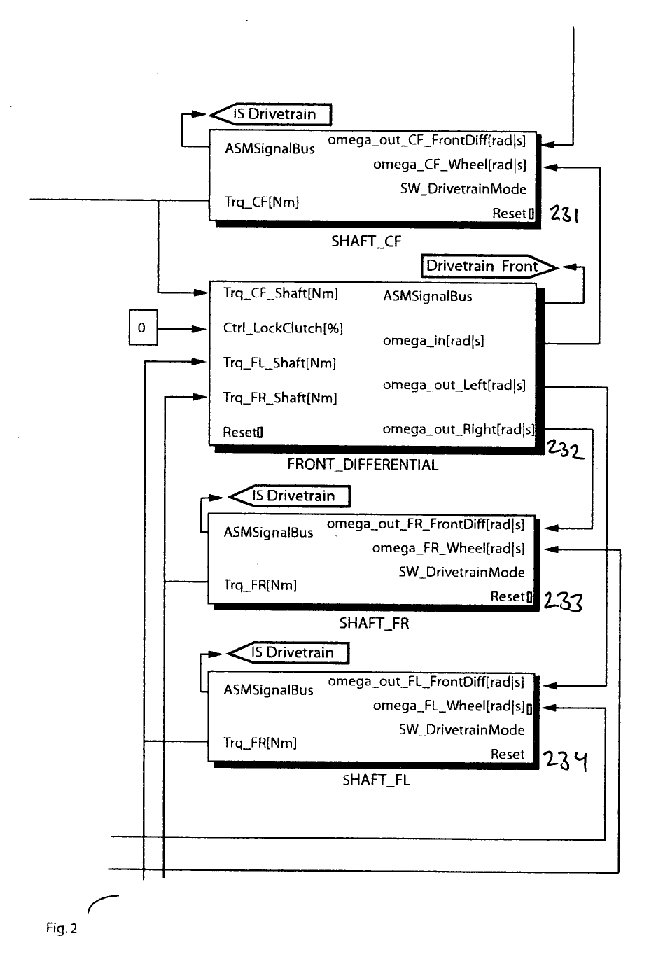

Each of the high level components can be comprised of one or more sub-components. For example, FIG. 2 shows modeling and interaction of some example sub-components of drive train 130. These include shaft_CF 231, front differential 232, shaft_FR 233, and shaft_FL 234. The sub-components could also be comprised of further sub-sub-components and so on.

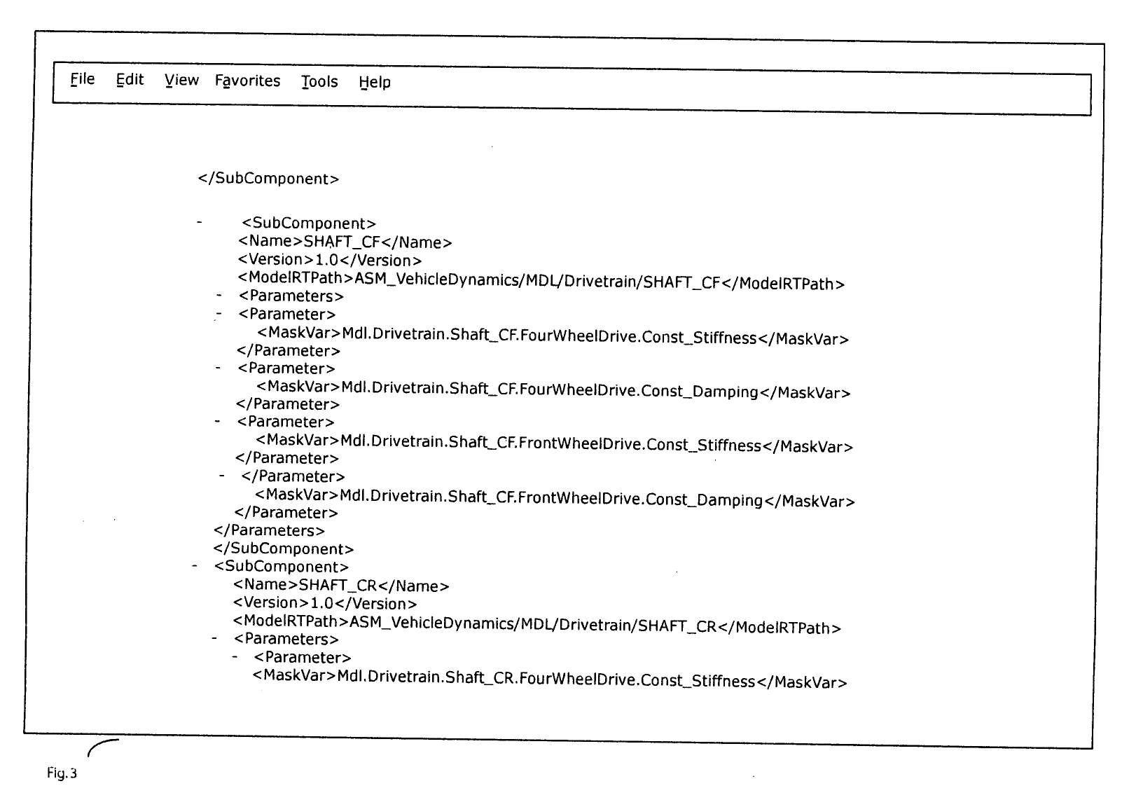

In one embodiment, each of the components and sub-components are modeled by a separate software object. For example, FIG. 3 shows an exemplary XML model for the shaft_CF sub-component.

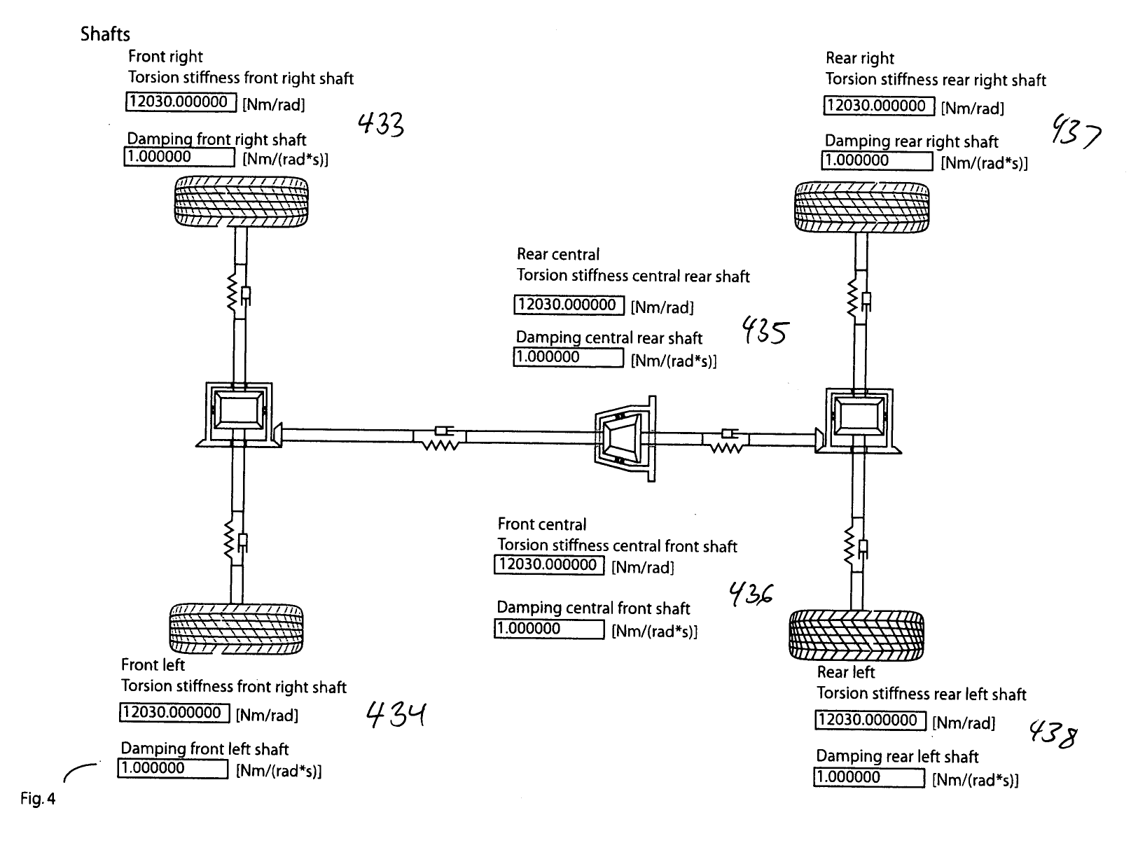

FIG. 4 in turn shows a representative GUI for interacting with the parameters for shafts of a particular model implementation. FIG. 4 shows exemplary GUIs for interacting with front right shaft 433, front left shaft 434, rear central shaft 435, front central shaft 436, rear right shaft 437, and rear right shaft 438.

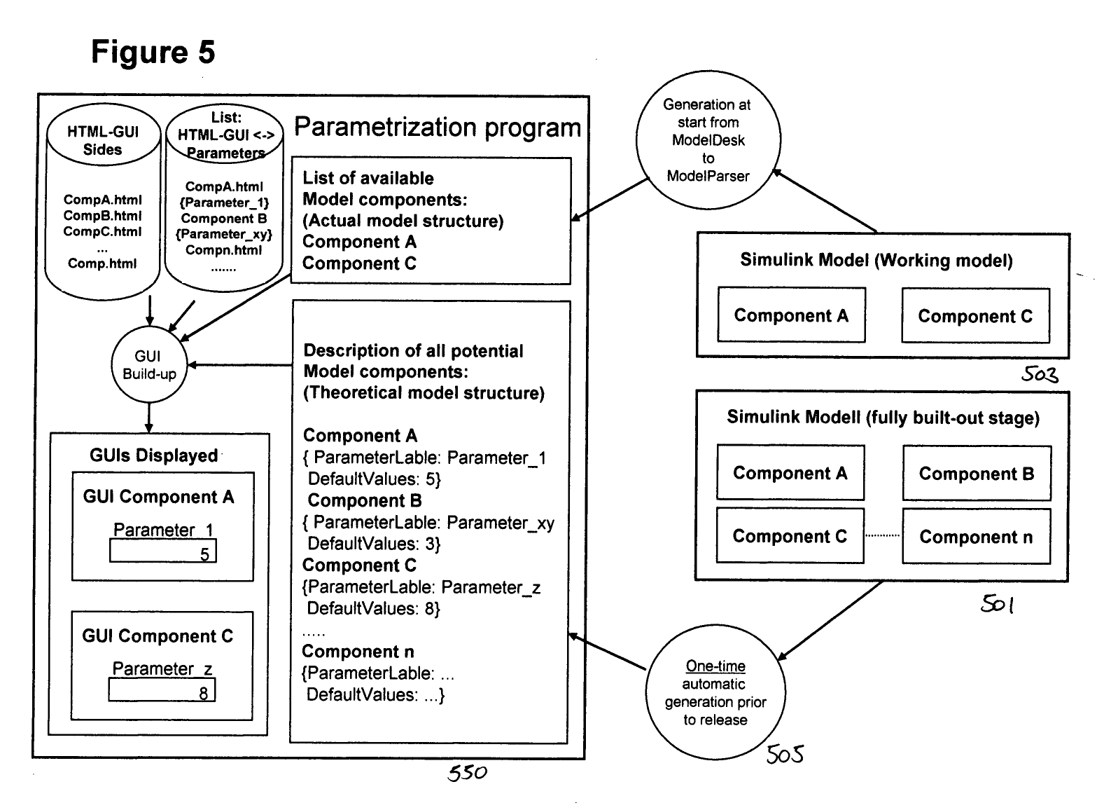

FIG. 5 shows a schematic representation of the operation of the simulator. The full Simulink model 501 represents a full collection of model components. As shown these components are generated prior to release 505. A sub-set of working components in a working model 503 is generated at run time. The parameterization program 550 uses the component models and associated HTML representations to generate the GUI.

According to the present invention, a working model is analyzed in relation to the simulation model components contained therein and that for each detected simulation model component a user interface is provided and displayed by automatic selection of at least one of the input/output masks associated with the simulation model component out of a mask databank and by automatic selection of the parameters associated with an input/output mask out of a parameter-mask allocation databank.

It is essential for the present invention to utilize a working simulation model containing only those simulation model components which are required for the desired simulation to be accomplished. In this manner, even the required storage memory for the working model will be distinctly reduced as compared to the prior art where in essence all potential model components are present in the simulation model, even though partly inactive, whereby the simulation hardware will be distinctly unburdened.

Based on the analysis of a working simulation model plotted according to the invention, the choice will then be automatically made of those user interfaces (GUIs) which are associated with a particular simulation model component, for example out of a mask databank provided for this purpose. By way of another databank, a mask parameter allocation databank, it is additionally possible to allocate to a chosen mask that parameter or those parameters which is or are to be input or output by way of a chosen mask.

By way of this automatic analysis of the working model and the automatic display of the pertinent user interface or interfaces—something that can be preferentially accomplished by a parameterization program—on the one hand the workload of an operator will be appreciably reduced, since a manual adjustment as now required in prior art is dispensed with, and the operating memory of the simulation hardware is preserved, since on the one hand there is displayed only the user interface actually needed for parameterization, and on the other, the parameters no longer needed are no longer re-recorded on the simulation hardware, thereby dispensing with unnecessary ballast.

In one especially preferred embodiment, provision may be made for the working model to be created by deleting unnecessary simulation model components out of a global model comprising all potential model components, whereby for each potential model component out of the global model there is at least one assigned entry in a mask and parameter-mask allocation databank.

This procedure is especially advantageous in that it permits going back to known or available global models. Based on this, the working model is produced by physically deleting unneeded model components out of the global model. Accordingly, the working model represents a subset of all simulation model components requiring only minimal memory space.

The global model may be outfitted with additional allocation data files, to comprise on the one hand the allocation from one user interface to a model component, and on the other the allocation of parameters to the user interface. These may involve the previously mentioned mask databanks and/or mask-parameter allocation databanks. In such a case, these databanks contain preferably all information pertaining to the global simulation model, so that consistent with the invention, following the analysis of the working model, even the databanks make it possible to generate only the actually required user interfaces and the pertinent parameters.

In this manner, a process according to the invention makes it possible to detect automatically the required user interfaces as well as the necessary GUI parameters and automatically match the user interface to the actual working simulation model.

This makes it more flexible to aggregate certain portions or components of large global simulation models (the end layout stage) into one working simulation model. This simultaneously accomplishes that the user interfaces, for example for the parameterization of these individually generated simulation models, are automatically matched.

It is thus possible to obtain one program for the administration of simulation models which, by comparison with the fixed static user interface according to prior art, now affords according to the invention a dynamic user interface.

In a further embodiment according to the invention, provision can also be made for a working model to be generated by the addition of at least one model component. In this way, there exists not only the possibility to generate a working model by deletion, that is, physical dissolution of unnecessary model components, but also, to the extent that a model has been created, for example, by deletion, to add once again components to this model. In this regard, it is important that the model component be one available in the global model, to ensure that each working model always comprises a subset of model components of the global model, thereby continuing to be available for the analysis of the working model according to the invented process.

Similarly, provision can be made in a further embodiment for a working model to be generated by the addition of at least one model component which is not a part of a global model. In such a case, care must be taken that the mask databank and the parameter-mask allocation databank be integrated with the masks and parameters of this new model component, thereby automatically expanding the global model, so that the process can once again be carried out with the expanded global model and the pertinent databank.

Once the working model is generated, the same can be downloaded onto simulation hardware before or after parameterization over the user interface. Parameterization may also take place after the working model has already been loaded onto the simulation hardware.

A real-time processor can be used for the simulation or more simply, a desktop computer may be used to test the working simulation model.

Provision may also be made for a control unit, notably a motor vehicle control unit, to be connected to the simulation hardware, to simulate the desired test environment for it.

Provision may also be made for at least one control unit to be itself simulated on the simulation hardware.

Thus, the process according to the invention may also be applied to so-called Off-line simulations. To this end, the simulation model is not downloaded onto the real-time hardware, but is channeled for execution on the PC development processor. The purpose is in the case of changes or novel developments of simulation models to be able to test the same without the need for costly simulation hardware with associated control units. In such a case, the physical unit can be replaced with Soft ECUs (control units depicted as model and/or software) and likewise be integrated as a control unit model in the simulation model, and both together channeled for execution on the PC development processor. Beyond that, there are model parts in the simulation model which can be tested off-line on the PC development processor without the attached control unit, regardless whether Soft ECU or physical control unit, in that they require no acknowledgment from the control unit. This might include, for example, changes in the diameter of the wheels or changes in the ride comfort components, as for example shock absorbers.

The advantages of the invention are once again summarized hereunder:

Working simulation models specifically need-designed and thereby requiring less memory storage on the simulation hardware

Less downloading time required onto the simulation hardware

Less data traffic, as there is no zero dating of deactivated model components

The GUI is dynamically built up to match the working model

In changing the working models, there is no need for manual adjustment of the user interface for administration

The advantages of interchangeable and reusable model components in different configurations are enhanced by the block-oriented modeling in GUI-assisted parameterization, thereby affording greater flexibility

The outcome is a more comfortable parameterization, since the only GUIs displayed are those for which a component is available in the working model.

The process starts first of all with an analysis of the working simulation model, whereby the available simulation model components are detected. In the process, the descriptive data file of the model structure is automatically produced (cf. FIG. 3).

In the next following step, the GUI/parameter allocation data file is checked for the requisite parameters and the applicable GUIs are detected, establishing in the process which GUIs are displayed for the pertinent working simulation model. The linkage of the applicable GUIs with the pertinent model component is thus established by the parameterization program. In the third step, the selected GUIs may be tested for incompatibility. Such incompatibilities may occur when the GUIs exhibit parameters of different simulation model components and in the process, one parameter is contained which belongs to a simulation model component not at this time contained in the working simulation model. An automatic matching in the GUI may also comprise along with the input/output of all GUIs also changes in the GUI (for example greying out of input fields).

For the automatic matching of the global user interface, the procedure is as follows:

System Expansion/Generation

1. Generation of the global simulation model with an excess number of all components.
2. Automatic generation of the descriptive file for all model components contained in the ultimate layout stage of the model structure. This is accomplished by a script which the model analyzes (scans) and enters all relevant information (model component parameters, attributes such as for example parameter label, parameter type, default value etc.) in the data file for example of an XML data file (theoretical model structure).
3. The parameterizing program reads this XML file (for a description of all potential model components, cf. FIG. 5).
4. Generated at the same time is the HTML GUI-to-model component (manually, for example with the FrontPage), as well as the databank with the parameter-to-mask allocation.
   System Application
1. At the start, a working model is made up of the model components of a Simulink Library (in a typical case, the user would make use of a sample model).
2. The parameterizing program is started.
3. The parameterizing program analyzes the working model and identifies thereby the available model components whose GUI sides need to be displayed (for a list of available model components=actual model structure, cf. FIG. 5). During this phase, a consistency check is additionally performed as to whether the model components of the working model are also contained in the descriptive file of all model components (final layout stage=theoretical model structure).
4. The pertinent GUIs of the model components of the working model are displayed. FIG. 4 shows for example such a GUI for parameterization. This could signify that one of the six input GUIs for the parameter is automatically deleted, supplemented or modified, when a model part of a model component for this parameterization-GUI changes or is no longer available.

1-6. (canceled)

7. A method for the parameterization of a software-implemented working model of a simulation environment comprising:
loading a plurality of simulation model components onto simulation hardware,
creating a working model by running the simulation model components on the simulation hardware,
analyzing the working model in relation to the simulation model components contained therein,
generating and displaying a user interface for each simulation model component by automatically selecting the user interface out of a mask databank, wherein the mask databank contains at least one input/output mask allocated to the simulation model component and automatically selecting parameters allocated to the input/output mask out of a parameter-mask allocation databank.

8. The method of claim 7 used for the simulation of a motor vehicle control system running on the simulation hardware.

9. The method of claim 7 wherein the working model is generated by the deletion of unneeded simulation model components out of a global model comprising all potential model components, whereby for each potential model component of the global model, there exists at least one allocated entry in the mask databank and parameter-mask allocation databank.

10. The method of claim 7 wherein the working model is generated by the addition of at least one model component to an existing working model.

11. The method of claim 7 wherein the working model is generated by the addition of at least one model component, which is not part of a global model, and that the mask databank and the parameter-mask allocation databank are supplemented by the masks and parameters of the model component.

12. The method of claim 7 wherein the analysis of the working model and the display of the user interface takes place by means of a parameterization program.
